(19) United States
(12) Patent Application Publication
(10) Pub. No.: US 2020/0190848 A1
(43) Pub. Date: Jun. 18, 2020

(54) VEHICLE DOOR DEVICE

(71) Applicant: Toyota Jidosha Kabushiki Kaisha, Toyota-shi Aichi-ken (JP)

(72) Inventors: Kazuki Murata, Nisshin-shi (JP); Tatsuya Shimizu, Okazaki-shi (JP)

(21) Appl. No.: 16/710,506

(22) Filed: Dec. 11, 2019

(30) Foreign Application Priority Data
Dec. 14, 2018 (JP) 2018-234754

(51) Int. Cl. E05B 5/02; E05B 81/14; E05B 83/36

(52) U.S. Cl. CPC E05B 5/003; B60J 5/04; E05B 83/36; E05B 81/14

(57) ABSTRACT

A door handle projecting/pulling-in mechanism has a spring and an alternating mechanism. The spring urges the door handle such that the door handle is stored within a door main body. The alternating mechanism is set such that a distal end portion of a movable portion faces the door handle, and the movable portion travels reciprocally along a door thickness direction. Against urging force of the spring, the alternating mechanism can switch between a first state, in which the alternating mechanism maintains the door handle at a first position of being even with an outer surface of the door main body, and a second state, in which the alternating mechanism maintains the door handle at a second position at which the door handle can be grasped.

### CROSS-REFERENCE TO RELATED APPLICATION

This application claims priority under 35 USC 119 from Japanese Patent Application No. 2018-234754, filed on Dec. 14, 2018, the disclosure of which is incorporated by reference herein.

### BACKGROUND

### Technical Field

The present disclosure relates to a vehicle door device.

### Related Art

Techniques relating to handle devices of vehicle doors are known. For example, Japanese Patent Application Laid-Open (JP-A) No. 2017-66605 discloses a technique relating to an outside handle device for a vehicle in which, at times when an outside handle is not being operated, the outside handle is disposed such that the outer surface thereof is even with the outer surface of an outer panel. To describe this briefly, in this technique, when the outside handle is pushed to a motor operation position by a vehicle occupant, a switch is pushed, and the outside handle is rotated to a grasping position (a position at which the outside handle can be operated). Then, when the outside handle that is disposed at the grasping position is pulled by the vehicle occupant and is rotated to an operation position, locking of the door is released.

By the way, in a structure in which the door handle is accommodated and disposed so as to be able to rotate around an axis that runs along the door vertical direction with respect to the door main body and such that the outer surface of the door handle is made even with the outer surface of the door main body, there are cases in which the door handle is rotated and made to project-out manually. In such cases, it is thought to employ a structure that, in consideration of the storing of the door handle, urges the door handle toward the door main body side.

However, in such a structure, even if the door handle is manually rotated and made to project-out, the door handle will return to the door main body side due to the urging force, and therefore, the convenience of use at the time when the user grasps the door handle is poor.

### SUMMARY

The present disclosure provides a vehicle door device that may improve the convenience of use by maintaining a projected-out state of a door handle when the door handle is grasped, and that may return the door handle to a state of being disposed such that the outer surface thereof is made even with the outer surface of the door main body when the door main body is set in a closed state.

A first aspect of the present disclosure is a vehicle door device including: a latching mechanism provided at a door main body of a vehicle, wherein, when the door main body is in a closed state, the latching mechanism being configured to switch between a latching state, in which a latch engages with a striker that is at a vehicle body side and opening of the door main body is restricted, and an unlatching state, in which the latch is not engaged with the striker and opening of the door main body is not restricted; a door handle provided at the door main body, the door handle being configured to move between a first position in which the door handle is disposed to be even with an outer surface of the door main body, and a second position in which at least a portion of the door handle projects-out toward a vehicle outer side with respect to the first position and in which an operator can grasp the door handle, the door handle being permitted to move from the first position toward an inner side of the door main body; and a door handle projecting/pulling-in mechanism being configured to carry out a door handle projecting operation, in which the door handle projecting/pulling-in mechanism moves the door handle from the first position to the second position and maintains a state in which the door handle is at the second position, and a door handle pulling-in operation, in which the door handle projecting/pulling-in mechanism moves the door handle from the second position to the first position and maintains a state in which the door handle is at the first position, the door handle projecting/pulling-in mechanism including: an urging member being configured to urge the door handle to be stored within the door main body, and an alternating mechanism that carries out an alternating operation, the alternating mechanism being configured such that a distal end portion of a movable portion faces the door handle and the movable portion travels along a door thickness direction, and the alternating mechanism being able to, against urging force of the urging member, switch between a first state in which the door handle is maintained at the first position and a second state in which the door handle is maintained at the second position, wherein, when an outer surface of the door handle in the first position is pushed and the door handle moves toward the inner side of the door main body, the alternating mechanism carries out a switching operation from the first state to the second state, by the movable portion being pushed in a direction toward a vehicle inner side by a portion of an inner surface side of the door handle and the movable portion being made to travel a stroke in a direction toward a vehicle outer side, and wherein, when the latch is pushed by the striker and rotates due to the door main body being moved in a direction of a closed position, the alternating mechanism carries out a switching operation from the second state to the first state, by the movable portion being pushed in the direction toward the vehicle inner side by an interlocking mechanism that operates in accordance with rotation of the latch and the movable portion being made to travel a stroke in the direction toward the vehicle inner side.

In accordance with the first aspect of the present disclosure, when the door main body is in a closed state, the latching mechanism that is provided at the door main body of the vehicle can switch between a latching state, in which the latch engages with the striker that is at the vehicle body side and opening of the door main body is restricted, and an unlatching state, at which the latch is not engaged with the striker and opening of the door main body is not restricted. Further, the door handle that is provided at the door main body can move between a first position of being disposed so as to be even with the outer surface of the door main body, and a second position that is a position at which a least a portion of the door handle projects-out toward the vehicle outer side with respect to the first position and an operator can grasp the door handle. Moreover, movement of the door handle from the first position toward the inner side of the door main body is permitted. Further, the door handle projecting/puling-in mechanism carries out a door handle projecting operation, in which the door handle projecting/pulling-in mechanism moves the door handle from the first position to the second position and maintains the state in which the door handle is at the second position, and a door handle pulling-in operation, in which the door handle projecting/pulling-in mechanism moves the door handle from the second position to the first position and maintains the state in which the door handle is at the first position.

The urging member of the door handle projecting/pulling-in mechanism urges the door handle such that the door handle is stored within the door main body. Further, the alternating mechanism of the door handle projecting/pulling-in mechanism is a mechanism that carries out an alternating operation, and the distal end portion of the movable portion faces the door handle, and the movable portion travels reciprocally along the door thickness direction. The alternating mechanism can, against the urging force of the urging member, switch between a first state of maintaining the door handle at the first position and a second state of maintaining the door handle at the second position.

Here, at the alternating mechanism, switching operation from the first state to the second state is carried out due to, when the outer surface of the door handle that is at the first position is pushed and the door handle moves toward the inner side of the door main body, the movable portion being pushed and operated in the direction toward the vehicle inner side by a portion of an inner surface side of the door handle, and the movable portion traveling a stroke in the direction toward the vehicle outer side. As a result, the door handle is maintained at the second position by the alternating mechanism, and therefore, the operator can easily grasp and pull the door handle that is disposed at the second position. Further, at the alternating mechanism, switching operation from the second state to the first state is carried out due to, when the latch is pushed by the striker and rotates due to the door main body being moved in the direction of the closed position, the movable portion being pushed and operated in the direction toward the vehicle inner side by an interlocking mechanism that operates in accordance with rotation of the latch, and the movable portion being made to travel a stroke in the direction toward the vehicle inner side. Therefore, there is no need to separately carry out an operation for returning the door handle.

A second aspect of the present disclosure, in the above first aspect, may further include an electric unlatching operation mechanism being configured to move the latching mechanism from the latching state to the unlatching state due to an electric actuator operating by operation of a switch, wherein the electric unlatching operation mechanism may be structured such that, when the outer surface of the door handle in the first position is pushed and the door handle moves toward the inner side of the door main body, the switch is operated by another portion of the inner surface side of the door handle.

In accordance with the second aspect of the present disclosure, when the outer surface of the door handle that is at the first position is pushed and the door handle moves toward the inner side of the door main body, the switch is operated by another portion of the inner surface side of the door handle. Further, due to the switch being operated, the electric actuator operates, and the electric unlatching operation mechanism moves the latching mechanism from the latching state to the unlatching state. In this way, the operator can switch the latching mechanism from the latching state to the unlatching state by the single action of pushing the outer surface of the door handle that is at the first position.

In a third aspect of the present disclosure, in the above-described aspects, when the door main body is operated in an opening direction from the second position, the door handle may move to a third position at which the door handle projects-out further toward the vehicle outer side than at the second position, in a state in which the door handle is not supported by the alternating mechanism, and the vehicle door device may include a mechanical unlatching operation mechanism that, in a case in which the latching mechanism is in the latching state, when the door handle moves from the second position to the third position, moves the latching mechanism from the latching state to the unlatching state interconnectedly with movement of the door handle.

In accordance with the third aspect of the present disclosure, when the door main body is operated in an opening direction from the second position, the door handle moves to a third position at which the door handle projects-out further toward the vehicle outer side than when at the second position, in a state in which the door handle is not supported by the alternating mechanism. In a case in which the latching mechanism is in the latching state, when the door handle moves from the second position to the third position, the mechanical unlatching operation mechanism moves the latching mechanism from the latching state to the unlatching state interconnectedly with movement of the door handle.

In accordance with the above-described aspects, the vehicle door device of the present disclosure may improve the convenience of use by maintaining a projected-out state of a door handle when the door handle is grasped, and that may return the door handle to a state of being disposed such that the outer surface thereof is made even with the outer surface of the door main body when the door main body is set in a closed state.

### BRIEF DESCRIPTION OF THE DRAWINGS

Exemplary embodiments will be described in detail based on the following figures, wherein:

FIG. 1 is a schematic side view illustrating the structure of a portion of an automobile to which a vehicle door device relating to an exemplary embodiment is applied;

FIG. 2 is a perspective view illustrating the schematic structure of the vehicle door device of FIG. 1 in a state of being seen from a door inner side and a vehicle rear side;

FIG. 3A is a drawing illustrating a state, in which a latch of a latching mechanism of FIG. 2 is disposed at a latching position, in a state of being seen from the door inner side;

FIG. 3B is a drawing illustrating the state seen from the arrow 3B direction of FIG. 3A;

FIG. 4 is a horizontal sectional view illustrating a state in which a door handle of FIG. 2 is disposed at a first position;

FIG. 5 is a vertical sectional view illustrating the state in which the door handle of FIG. 2 is disposed at the first position;

FIG. 6 is a perspective view illustrating a portion of the vehicle door device of FIG. 2, in a state of being seen from the door inner side and a vehicle front side;

FIG. 7 is an exploded perspective view in which an alternating mechanism of FIG. 2 and structures at the periphery thereof are illustrated in an exploded manner;

FIG. 8 is a horizontal sectional view illustrating a state in which an outer surface of the door handle of FIG. 2 is pushed;

FIG. 9 is a vertical sectional view illustrating the state in which the outer surface of the door handle of FIG. 2 is pushed;

FIG. 10 is a perspective view illustrating a state, in which an electric unlatching operation mechanism is operated, in a state of being seen from the door inner side;

FIG. 11A is a drawing illustrating a state, in which the electric unlatching operation mechanism is operated, in a state of being seen from the door inner side;

FIG. 11B is a drawing illustrating the state seen from the arrow 11B direction of FIG. 11A;

FIG. 12 is a horizontal sectional view illustrating a state in which the door handle of FIG. 2 is disposed at a second position;

FIG. 13 is a vertical sectional view illustrating the state in which the door handle of FIG. 2 is disposed at the second position;

FIG. 14 is a horizontal sectional view illustrating a state in which the door handle, which is the state illustrated in FIG. 12, is pulled and reaches a third position;

FIG. 15A is a drawing illustrating a change in the state of a crank mechanism, at a time when the door handle is in the state illustrated in FIG. 12, in a state of being seen from the door inner side;

FIG. 15B is a drawing illustrating the state of the crank mechanism at a time when the door handle is in the state illustrated in FIG. 14;

FIG. 16 is a perspective view illustrating a state, in which a mechanical unlatching operation mechanism is operated, in a state of being seen from the door inner side;

FIG. 17A is a drawing illustrating the state, in which the mechanical unlatching operation mechanism is operated, in a state of being seen from the door inner side;

FIG. 17B is a drawing illustrating the state seen from the arrow 17B direction of FIG. 17A;

FIG. 18A is a drawing illustrating a state, in which operations of the latching mechanism, a wire lever, and the like at a time when the door handle is pulled-in to the first position, are seen from the door inner side, and illustrates an unlatching state;

FIG. 18B is a drawing illustrating a state in which a striker is pushing the latch at a time of closing a door;

FIG. 18C is a drawing illustrating a latching state;

FIG. 19A is a vertical sectional view illustrating operations of a door handle projecting/pulling-in mechanism and the door handle and the like at the time when the door handle is pulled-in to the first position, and is a drawing illustrating the state of the door handle projecting/pulling-in mechanism and the like at a time when a wire is in the state illustrated in FIG. 18A;

FIG. 19B is a drawing illustrating the state of the door handle projecting/pulling-in mechanism and the like at a time when the wire is in the state illustrated in FIG. 18B; and

FIG. 19C is a drawing illustrating the state of the door handle projecting/pulling-in mechanism and the like at a time when the wire is in the state illustrated in FIG. 18C.

### DETAILED DESCRIPTION

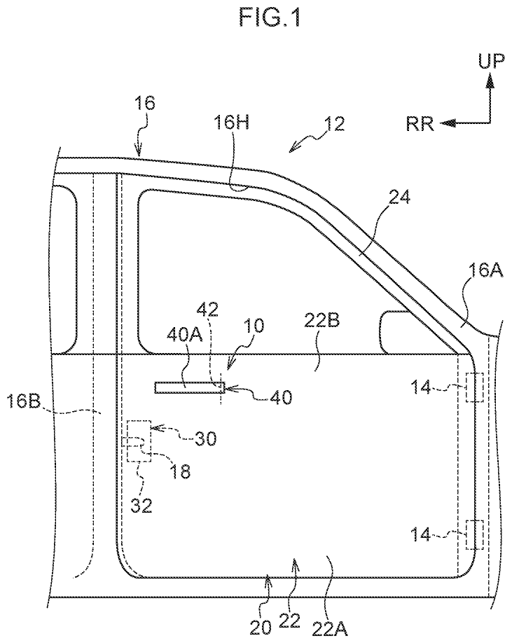

A vehicle door device relating to an exemplary embodiment of the present disclosure is described by using FIG. 1 through FIG. 19C. Note that arrow RR that is illustrated appropriately in these drawings indicates the vehicle rear side, arrow UP indicates the vehicle upper side, arrow OUT indicates the vehicle transverse direction outer side, and arrow IN indicates the vehicle transverse direction inner side.

A portion of an automobile 12, which is structured such that a vehicle door device 10 relating to a present exemplary embodiment is applied thereto, is illustrated in FIG. 1 in a schematic side view. As illustrated in this drawing, the automobile 12 has a side door 20. The front end portion of the side door 20 is rotatably connected via a pair of upper and lower hinges 14 to an A pillar 16A of a vehicle body 16. The side door 20 can open and close a door opening 16H for vehicle occupant ingress/egress that is formed in a side portion of the vehicle body 16. Note that, in the state in which the side door 20 is closed, the door thickness direction coincides with the vehicle transverse direction. In the following explanation, in cases in which description is given by merely using directions that are based on the vehicle such as the vehicle transverse direction and the vehicle longitudinal direction and the like, these directions refer to the directions when viewing in a state in which the side door 20 is closed, unless otherwise specified.

The side door 20 has a door main body 22, a door frame 24 for a window frame that is joined to the upper portion of the door main body 22, and a door trim (not illustrated) that is mounted to the vehicle cabin inner side of the door main body 22. The door main body 22 is structured to include a door outer panel 22A that is made of metal and that structures an outer plate that is disposed at the vehicle transverse direction outer side of the door main body 22, and a door inner panel (not illustrated) that is made of metal and that structures an inner plate that is disposed at the vehicle transverse direction inner side of the door main body 22. The door outer panel 22A extends in the vehicle vertical direction and the vehicle longitudinal direction. In a horizontal sectional view that is seen from the vehicle upper side, the vehicle longitudinal direction intermediate portion of the door outer panel 22A is convex toward the vehicle transverse direction outer side, and, in a vertical sectional view that is seen from the vehicle front side, the vehicle vertical direction intermediate portion of the door outer panel 22A is convex toward the vehicle transverse direction outer side. In contrast, the door inner panel (not illustrated) that structures the inner plate of the door main body 22 extends in the vehicle vertical direction and the vehicle longitudinal direction, and the front and rear ends and the lower end thereof are joined by hemming to the front and rear ends and the lower end of the door outer panel 22A. Due thereto, an internal space is formed in the door main body 22.

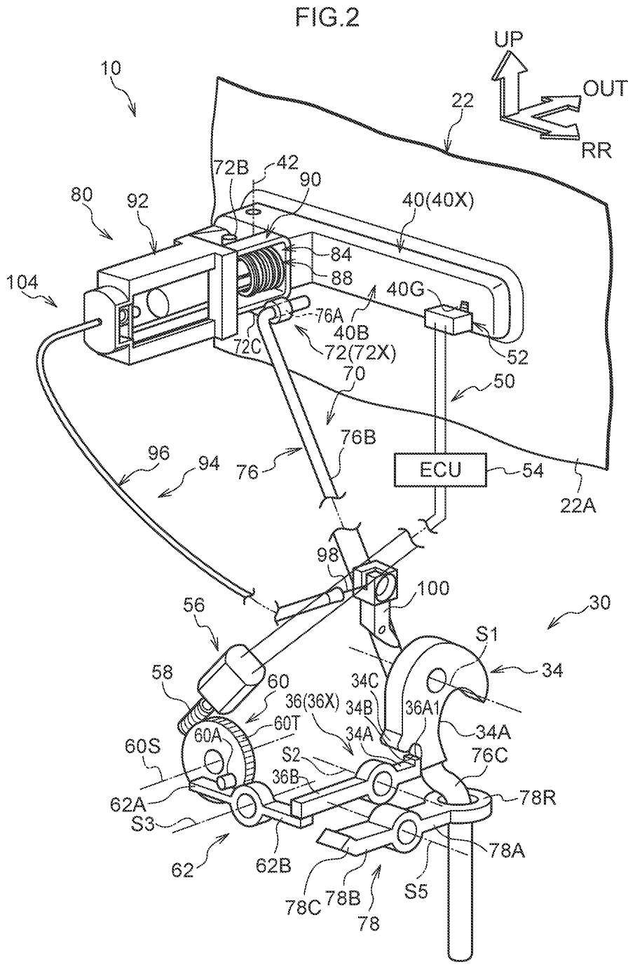

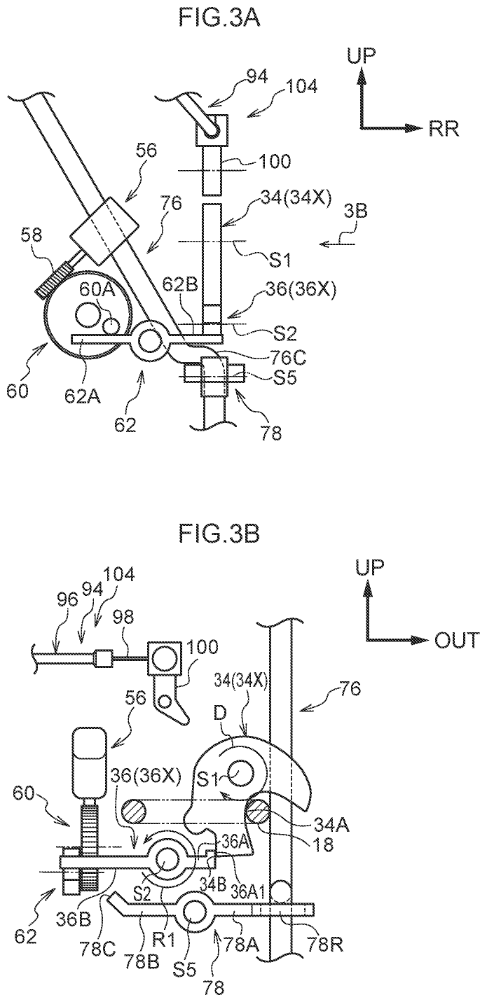

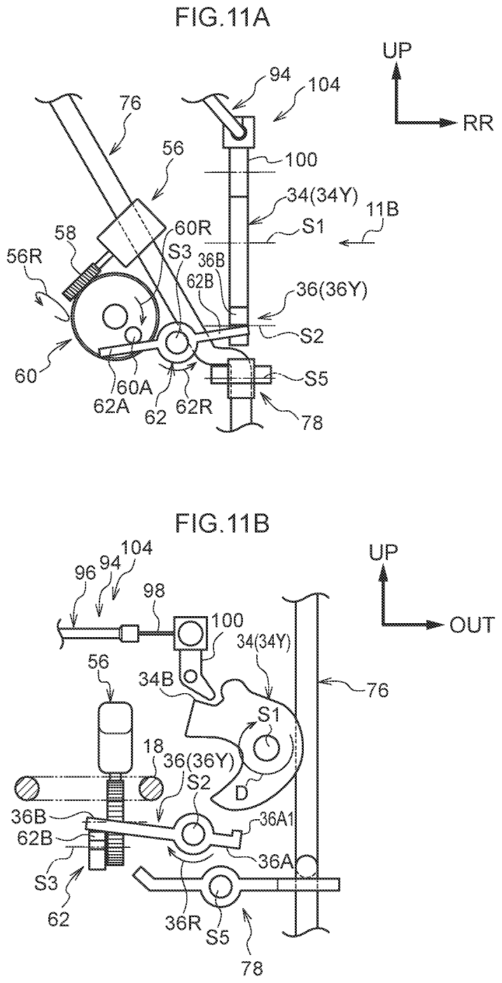

The schematic structure of the vehicle door device 10 relating to the present exemplary embodiment is illustrated in FIG. 2 in a perspective view in a state of being seen from the door inner side and the vehicle rear side. As illustrated in FIG. 2, a latching mechanism 30 is provided at the inner side of the door main body 22. Note that, in FIG. 2, in order to make the structure of the latching mechanism 30 easy to understand, the latching mechanism 30 and the portions at the periphery thereof are illustrated in an enlarged manner. As illustrated in FIG. 1, the latching mechanism 30 has a base member 32 (illustrated schematically) that is disposed at the vehicle rear side end portion of the door main body 22 and is fixed to the door main body 22. The latching mechanism 30 has a latch 34 that is supported at the base member 32 via a supporting shaft S1 (only the central axis thereof is illustrated in the drawings) that is illustrated in FIG. 2. The supporting shaft St is disposed with a direction that runs along the vehicle longitudinal direction being the axial direction thereof. The latch 34 can rotate around the supporting shaft S1 between a latching position 34X illustrated in FIG. 3B and an unlatching position 34Y illustrated in FIG. 11B, and is urged by an unillustrated spring toward the unlatching position 34Y illustrated in FIG. 11B (refer to arrow D).

As illustrated in FIG. 3B, an engaging concave portion 34A for restraining a striker 18 (see FIG. 1) is provided at the latch 34. As illustrated in FIG. 1, the striker 18 is fixed to a B pillar 16B1 of the vehicle body 16, and, although not illustrated, is formed in a U-shape as seen from the vehicle upper side. Further, at the time when the door main body 22 is in a closed state, the latching mechanism 30 can be switched between a latching state, in which the latch 34 that is disposed at the latching position 34X (refer to FIG. 38 for both) is engaged with the striker 18 that is at the vehicle body 16 side and opening of the door main body 22 is restricted, and an unlatching state, in which the latch 34 that is disposed at the unlatching position 34Y (refer to FIG. 11B for both) is not engaged with the striker 18 and opening of the door main body 22 is not restricted.

As illustrated in FIG. 2, a projecting portion 34C is formed at the outer peripheral side of the latch 34, and an anchor portion 34B is formed at the end portion of a region that is continuous with the projecting portion 34C and is shaped as a notch. Further, in the state in which the latch 34 is engaged with the striker 18 (see FIG. 3B), due to the anchor portion 34B being anchored on a distal end anchor portion 36A1 of a first arm portion 36A of a pole 36, rotation of the latch 34 is stopped. Note that the distal end anchor portion 36A 1 is a region that is convex toward the upper side at the distal end side of the first arm portion 36A.

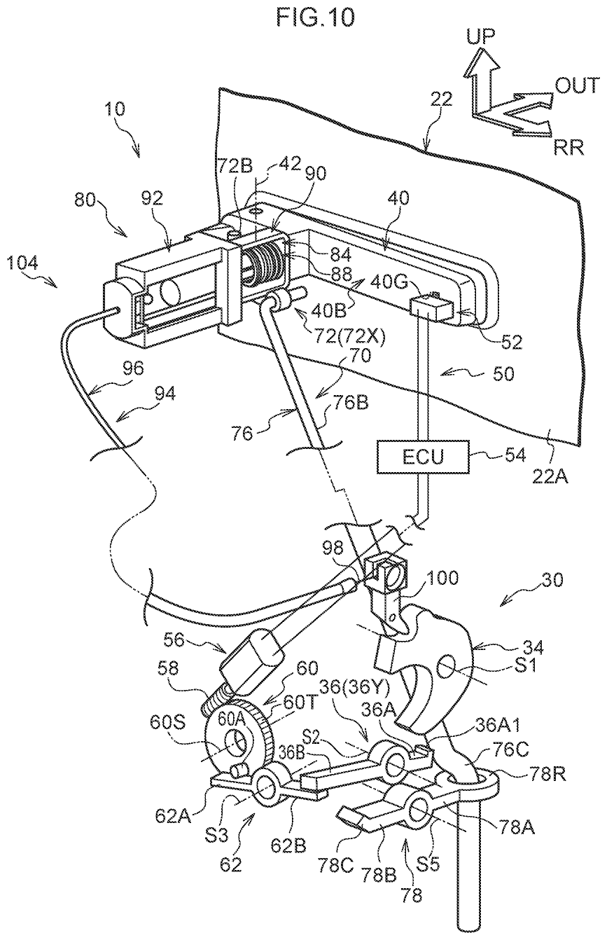

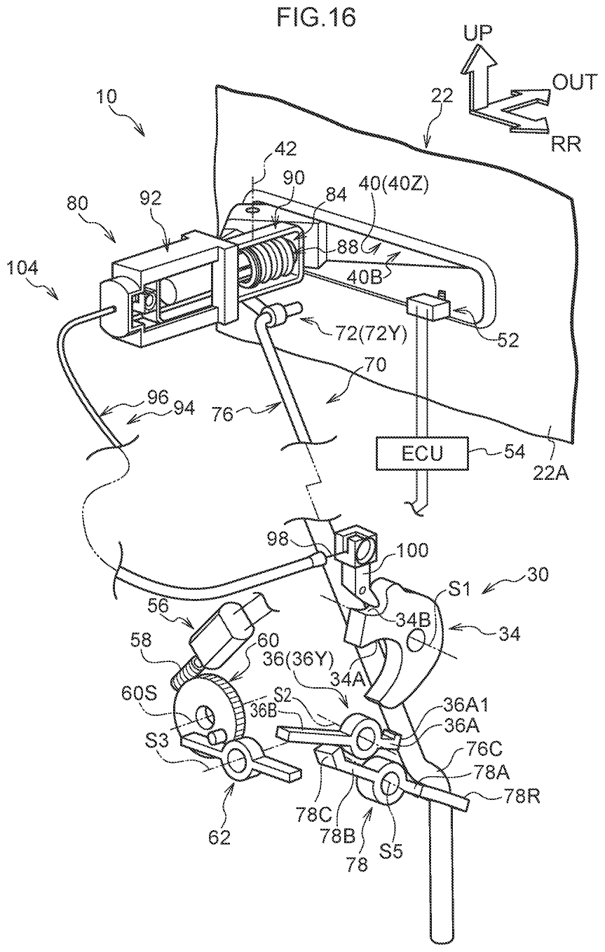

The pole 36 is supported at the base member 32 (see FIG. 1) via a supporting shaft S2 (only the central axis thereof is illustrated in the drawings). The supporting shaft S2 is disposed with a direction that runs along the vehicle longitudinal direction being the axial direction thereof. The pole 36 can rotate around the supporting shaft S2 between a locking position 36X that is illustrated in FIG. 2, FIG. 3A and FIG. 38, and an unlocking position 36Y that is illustrated in FIG. 10, FIG. 11A, FIG. 11B and the like. The pole 36 is urged by an unillustrated spring toward the locking position 36X that is illustrated in FIG. 3B (refer to arrow R1). The pole 36 is provided so as to operate interconnectedly with the rotation of a door handle (also called “outside handle”) 40 that is provided at the door main body 22 illustrated in FIG. 2. Due to the door handle 40 being operated, the pole 36 is rotated toward the unlocking position 36Y (see FIG. 10 and FIG. 16).

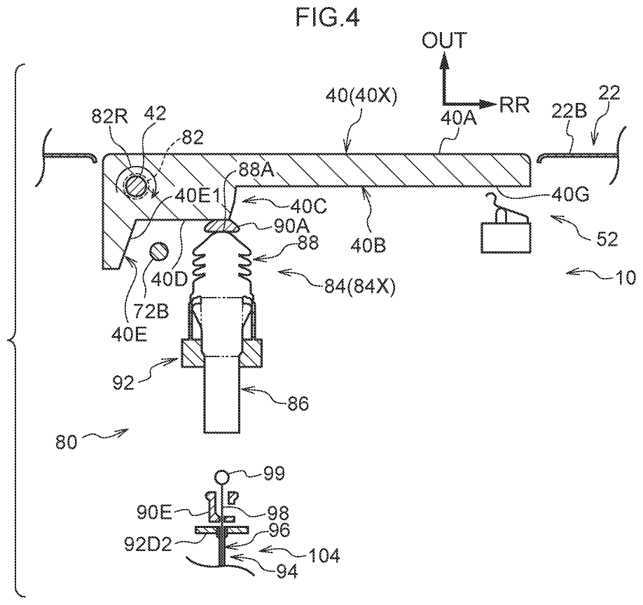

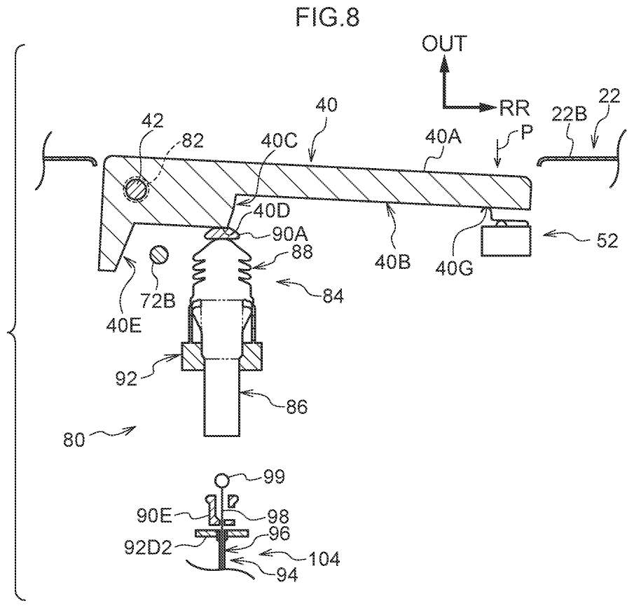

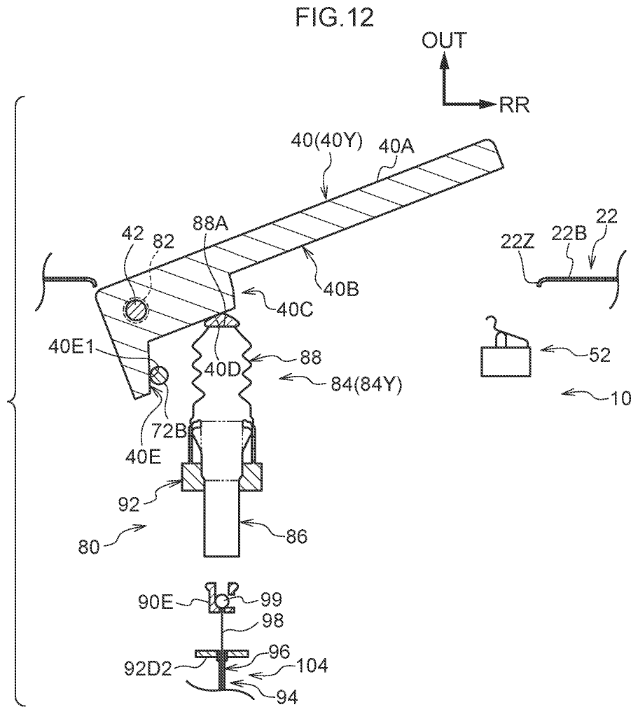

A horizontal sectional view of a state, in which the door handle 40 is disposed so as to be even with an outer surface 22B of the door main body 22, is illustrated in FIG. 4. The door handle 40 can move between a first position 40X, at which the door handle 40 is disposed so as to be even with the outer surface 22B of the door main body 22, and a second position 40Y, which is illustrated in FIG. 12 and is a position at which the majority of the door handle 40 (in a broad sense, a portion thereof) projects-out toward the vehicle outer side with respect to the first position 40X and an operator can grasp the door handle 40. Further, as illustrated in FIG. 8, movement of the door handle 40 from the first position 40X (see FIG. 4) toward the inner side of the door main body 22 is permitted. As illustrated in FIG. 1, the door handle 40 is disposed such that the left-right direction is the length direction thereof when viewing the door head-on. Due to the door handle 40 being rotated around the axis of a shaft 42 that runs along the door vertical direction, the door handle 40 can move between the first position 40X (see FIG. 4) and the second position 40Y (see FIG. 12). The shaft 42 is set at the end portion side that is at the vehicle longitudinal direction front side that is a length direction one side of the door handle 40, when viewing the door head-on.

As illustrated in FIG. 4, a convex portion 40C that projects-out toward the door inner side is formed at a region that is at the vehicle longitudinal direction front side (the length direction one side) of an inner surface 40B side of the door handle 40. The convex portion 40C has a flat surface 40D that faces the door inner side and extends along the length direction of the door handle 40, and a projecting portion 40E that projects-out further toward the door inner side from the vehicle longitudinal direction front side end portion of the flat surface 40D. The projecting portion 40E structures the vehicle longitudinal direction front side (length direction one side) end portion of the inner surface 40B side of the door handle 40. An inclined surface 40E1, which is inclined slightly toward the vehicle front side while heading toward the door inner side, is formed at the vehicle rear side surface of the projecting portion 40E.

As illustrated in FIG. 2, the vehicle door device 10 has an electric unlatching operation mechanism 50 for causing the pole 36 to operate interconnectedly with the operation of the door handle 40. The electric unlatching operation mechanism 50 has a switch 52 that is disposed so as to face and so as to be a predetermined interval apart from a vehicle longitudinal direction rear side (length direction another side) end portion 40G at the inner surface 40B side of the door handle 40. The electric unlatching operation mechanism 50 is structured such that, when the outer surface 40A of the door handle 40 that is at the first position 40X illustrated in FIG. 4 is pushed, and the door handle 40 moves toward the inner side of the door main body 22 as illustrated in FIG. 8, the switch 52 is operated by the vehicle longitudinal direction rear side end portion 40G at the inner surface 40B side of the door handle 40. As illustrated in FIG. 2, the switch 52 is connected to an ECU (illustrated as a block in the drawings, and also called “control device”) 54. When the switch 52 is operated by being pushed, the switch 52 can output a signal to the ECU 54. Further, an electric motor 56 that serves as an electric actuator for unlatching is connected to the ECU 54. When the switch 52 is pushed, the ECU 54 effects control so as to operate the electric motor 56 in accordance with the operation signal from the switch 52.

The electric motor 56 is supported at the base member 32 (see FIG. 1). A first gear 58 is coaxially fixed to the output shaft of the electric motor 56. The first gear 58 is meshed with a second gear 60. The second gear 60 has a larger diameter than the first gear 58, and is supported at the base member 32 (see FIG. 1) via a supporting shaft 60S (only the central axis thereof is illustrated in the drawings), and can rotate around the supporting shaft 60S. The supporting shaft 60S is disposed with a direction that runs along the vehicle transverse direction being the axial direction thereof. Teeth 60T are formed at the outer peripheral surface of the second gear 60. A projecting portion 60A that is shaped as a pin is formed at the side surface of the second gear 60 so as to project-out therefrom. The projecting portion 60A is disposed with the vehicle transverse direction being the axial direction thereof, and contacts the top surface of a first arm portion 62A of a lever 62. The lever 62 is supported at the base member 32 (see FIG. 1) via a supporting shaft S3 (only the central axis thereof is illustrated in the drawings), and can rotate around the supporting shaft S3. The supporting shaft S3 is disposed with a direction that runs along the vehicle transverse direction being the axial direction thereof. The bottom surface of the distal end side of a second arm portion 361 of the pole 36 contacts the top surface of the distal end side of a second arm portion 62B, which extends toward the side opposite the first arm portion 62A, at the lever 62. Note that the second arm portion 36B of the pole 36 extends toward the side opposite the first arm portion 36A at the pole 36.

Here, as illustrated in FIG. 11A, when the electric motor 56 operates and rotates (refer to arrow 56R), due to the first gear 58 and the second gear 60 rotating, the projecting portion 60A pushes the first arm portion 62A of the lever 62 down, and, interconnectedly therewith, the second arm portion 62B of the lever 62 pushes the second arm portion 36B of the pole 36 up. Then, as illustrated in FIG. 11B, when the second arm portion 36B of the pole 36 is pushed-up, the first arm portion 36A of the pole 36 falls, and the distal end anchor portion 36A1 of the first arm portion 36A of the pole 36 comes away from the anchor portion 34B of the latch 34. Further, when the distal end anchor portion 36A1 of the first arm portion 36A of the pole 36 comes away from the anchor portion 34B of the latch 34, the latch 34 rotates toward the unlatching position 34Y (refer to arrow D) against the urging force of the unillustrated spring.

Due to the above, at the electric unlatching operation mechanism 50 that is illustrated in FIG. 10, when the vehicle longitudinal direction rear side of the outer surface 40A of the door handle 40 illustrated in FIG. 1 is pushed, due to the switch 52 being operated by the vehicle longitudinal direction rear side end portion 40G at the inner surface 40B side of the door handle 40 illustrated in FIG. 10, the electric motor 56 operates, and the latching mechanism 30 is moved from the latching state to the unlatching state.

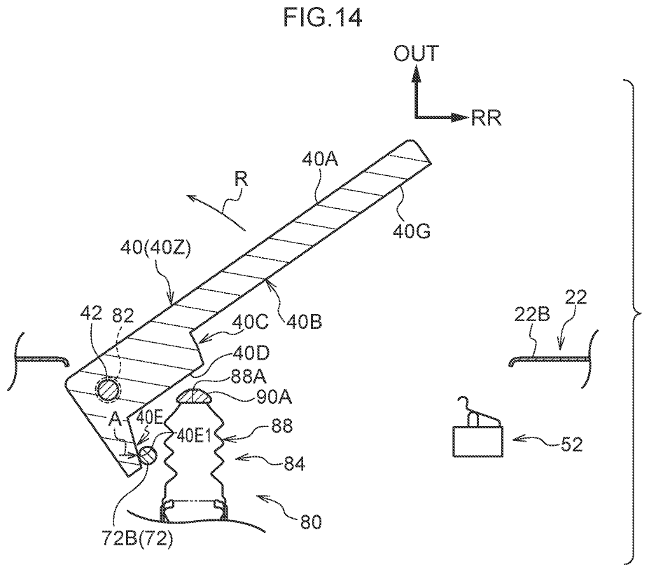

On the other hand, as illustrated in FIG. 14, when the door handle 40 is operated from the second position 40Y (see FIG. 12) in the direction of opening the door main body 22 (refer to arrow R), the door handle 40 moves to a third position 40Z at which the door handle 40 projects-out further toward the vehicle outer side than when at the second position 40Y (see FIG. 12). Further, as illustrated in FIG. 2, the vehicle door device 10 has a mechanical unlatching operation mechanism 70 for causing the door handle 40 and the pole 36 to mechanically operate interconnectedly.

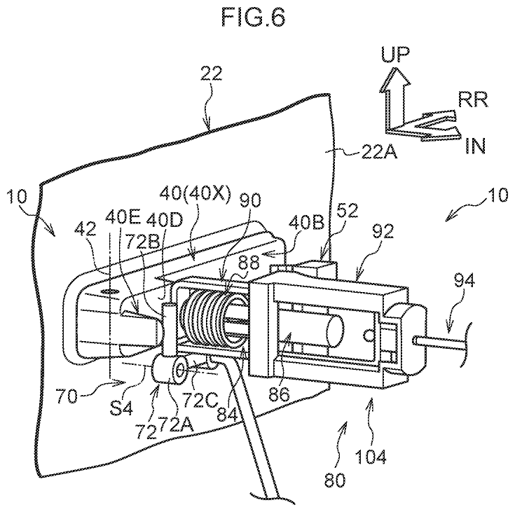

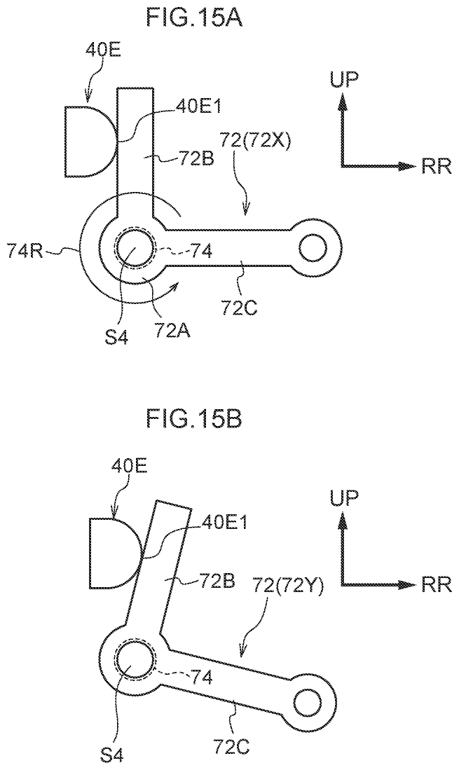

A perspective view of a state, in which a portion of the vehicle door device 10 is seen from the door inner side and the vehicle front side, is illustrated in FIG. 6. As illustrated in FIG. 6, the mechanical unlatching operation mechanism 70 has a crank mechanism 72 at the inner side of the door handle 40. The crank mechanism 72 is formed in an L-shape as seen from the vehicle transverse direction. A first arm portion 72B and a second arm portion 72C extend-out from a base portion 72A, and the crank mechanism 72 is supported at the door main body 22 side via a supporting shaft S4 (only the central axis thereof is illustrated in the drawings) that is provided at the base portion 72A. The supporting shaft S4 is disposed with a direction that runs along the vehicle transverse direction being the axial direction thereof. The crank mechanism 72 can rotate around the supporting shaft S4 between a reference position 72X illustrated in FIG. 15A and an operation position 72Y illustrated in FIG. 15B. The crank mechanism 72 is urged toward the reference position 72X illustrated in FIG. 15A (refer to arrow 74R) by a spring 74 for the crank mechanism (e.g., a torsion coil spring).

The first arm portion 72B of the crank mechanism 72 is disposed at a position of being apart from the inclined surface 40E1 that is at the inner surface 40B side of the door handle 40 that is disposed at the first position 40X illustrated in FIG. 4. Further, the first arm portion 72B contacts the inclined surface 40E1 that is at the inner surface 40B side of the door handle 40 that is disposed at the second position 40Y illustrated in FIG. 12, and is in a state of being pushed by the inclined surface 40E1 that is at the inner surface 40B side of the door handle 40 that is disposed at the third position 40Z illustrated in FIG. 14 (refer to arrow A).

As illustrated in FIG. 2, a distal end portion 76A, which is a portion of a rod 76 and is bent toward the door outer side, is mounted, so as to be rotatable around an axis that is in the vehicle transverse direction, to the distal end portion of the second arm portion 72C of the crank mechanism 72. The rod 76 has an intermediate portion 76B that is elongated and extends toward the vehicle rear and lower side, and a lower portion 76C that is bent in the shape of a crank from the lower end side of the intermediate portion 76B.

The lower portion 76C of the rod 76 is inserted-through a ring portion 78R of a lever 78 with a ring. The ring portion 78R is formed at the distal end side of a first arm portion 78A of the lever 78 with a ring, and is disposed with the vehicle vertical direction being the direction of passage therethrough. A bent portion 78C, which is bent obliquely toward the vehicle upper side and the vehicle transverse direction inner side, is formed at the distal end side of a second arm portion 78B that is at the side opposite the first arm portion 78A at the lever 78 with a ring. This bent portion 78C is disposed directly beneath the second arm portion 36B of the pole 36. The lever 78 with a ring is supported at the base member 32 (see FIG. 1) via a supporting shaft S5 (only the central axis thereof is illustrated in the drawings), and can rotate around the supporting shaft S5. The supporting shaft S5 is disposed with the direction that runs along the vehicle longitudinal direction being the axial direction thereof.

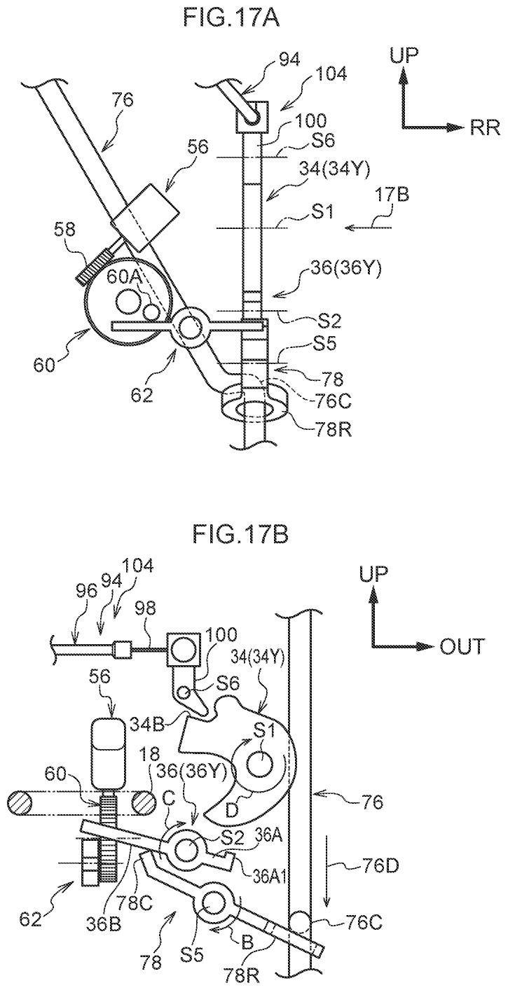

Here, when the door handle 40 is rotated from the second position 40Y illustrated in FIG. 12 to the third position 40Z illustrated in FIG. 14, the rod 76 falls due to the rotation of the crank mechanism 72 that is illustrated in FIG. 16 and that is pushed by the inclined surface 40E1 at the inner surface 40B side of the door handle 40. Then, as illustrated in FIG. 17A and FIG. 17B, when the rod 76 falls (refer to arrow 76D), the ring portion 78R of the lever 78 with a ring is pushed downward, and the lever 78 with a ring rotates (refer to arrow B), and the bent portion 78C of the lever 78 with a ring pushes the second arm portion 36B of the pole 36 upward. Due thereto, the pole 36 rotates (refer to arrow C), and the first arm portion 36A of the pole 36 falls, and the distal end anchor portion 36A1 of the first arm portion 36A of the pole 36 comes away from the anchor portion 34B of the latch 34. Further, when the distal end anchor portion 36A1 of the first arm portion 36A of the pole 36 comes away from the anchor portion 348 of the latch 34, the latch 34 rotates toward the unlatching position 34Y (refer to arrow D) by a spring (not illustrated).

Due to the above, at the mechanical unlatching operation mechanism 70 that is illustrated in FIG. 2, in a case in which the latching mechanism 30 is set in the latching state, when the door handle 40 moves from the second position 40Y (see FIG. 12) to the third position 40Z (see FIG. 14), interconnectedly with the movement of the door handle 40, the latching mechanism 30 is moved from the latching state to the unlatching state as illustrated in FIG. 16.

On the other hand, the vehicle door device 10 of the present exemplary embodiment has a door handle projecting/pulling-in mechanism 80 that carries out a door handle projecting operation, in which the door handle projecting/pulling-in mechanism 80 moves the door handle 40 illustrated in FIG. 4 from the first position 40X to the second position 40Y illustrated in FIG. 12 and maintains the state in which the door handle 40 is at the second position 40Y, and a door handle pulling-in operation, in which the door handle projecting/pulling-in mechanism 80 moves the door handle 40 from the second position 40Y to the first position 40X illustrated in FIG. 4 and maintains the state in which the door handle 40 is at the first position 40X. The door handle projecting/pulling-in mechanism 80 is structured to include a spring 82 that serves as an urging member and urges the door handle 40 to be stored within the door main body 22, and an alternating mechanism 84 that is provided at the door inner side with respect to the convex portion 40C that is at the inner surface 40B side of the door handle 40. Note that hatching of the cross-section of the alternating mechanism 84 is omitted from the cross-sectional views among FIG. 1 through FIG. 19C, in order to make the drawings easy to understand. The spring 82 is a torsion coil spring as an example, and urges the door handle 40 such that the door handle 40 is pulled-in to a position which is slightly further toward the door inner side than the first position 40X (but is a position at which the switch 52 is not operated by the door handle 40).

The alternating mechanism 84 is a mechanism that carries out alternating operation, and has a movable portion 88, and is set such that a distal end portion 88A of the movable portion 88 faces the door handle 40, and the movable portion 88 travels reciprocally along the door thickness direction. The alternating mechanism 84 can switch, against the urging force of the spring 82, between a first state of maintaining the door handle 40 at the first position 40X, and a second state of maintaining the door handle 40 at the second position 40Y (see FIG. 12). Note that, when the door handle 40 is operated from the second position (see FIG. 12) in the direction of opening the door main body 22, in the state in which the door handle 40 is not supported by the alternating mechanism 84 as illustrated in FIG. 14, the door handle 40 moves to the third position 40Z at which the door handle 40 projects-out further toward the vehicle outer side than at the second position (see FIG. 12).

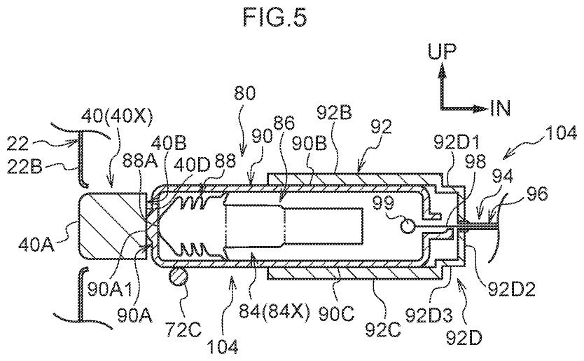

The state of the alternating mechanism 84 and the portions at the periphery thereof, in the state in which the door handle 40 is disposed at the first position 40X, is illustrated in FIG. 5 in a vertical sectional view. As illustrated in FIG. 5 and FIG. 6, the door handle projecting/pulling-in mechanism 80 has a case 90 that houses the alternating mechanism 84, and has a base member 92 that slidingly houses a portion of the case 90 and to which a side portion of the alternating mechanism 84 is fixed. The base member 92 is mounted to the door main body 22 via a mounting member (not illustrated).

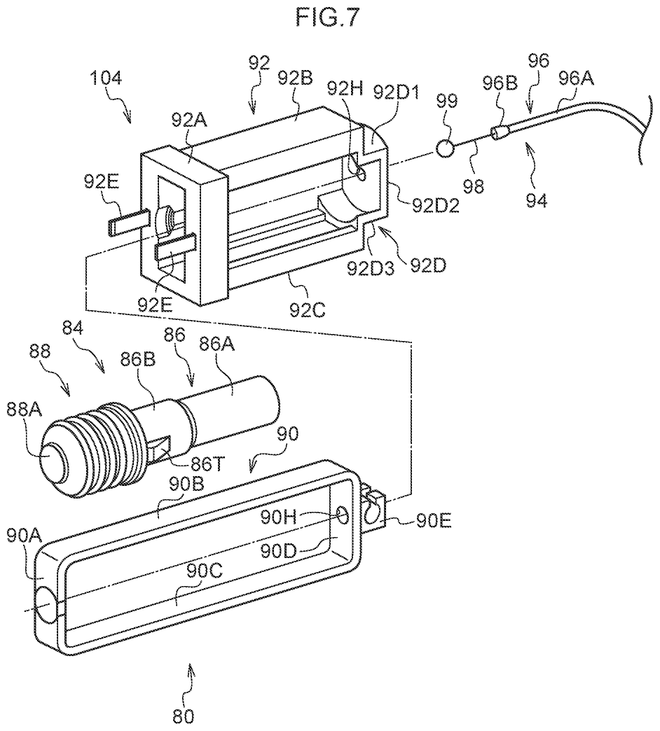

The structure of the alternating mechanism 84 and the portions at the periphery thereof is illustrated in FIG. 7 in an exploded perspective view. As illustrated in FIG. 7, the alternating mechanism 84 is a structural body that is substantially shaped as a shaft on the whole, and is provided such that a non-movable portion 86 and the movable portion 88 are lined-up in the axial direction. The non-movable portion 86 is structured so as to include a case portion that is substantially shaped as a cylindrical tube that forms the outer shape of the non-movable portion 86. The non-movable portion 86 has a first structural portion 86A that is provided at the side opposite the side of the movable portion 88, and a second structural portion 86B that is provided between the first structural portion 86A and the movable portion 88 and whose diameter is larger than that of the first structural portion 86A. Convex portions 86T for fixing that are for fixing to the base member 92 are formed to project-out from the side portions of the second structural portion 86B. Further, the movable portion 88 can travel reciprocally in the axial direction thereof, and the end portion thereof, which is at the side opposite the non-movable portion 86 side, is the distal end portion 88A.

The alternating mechanism 84 can assume a closed state 84X (see FIG. 4), at which the alternating mechanism 84 maintains itself in a state in which the distance from the non-movable portion 86 to the distal end portion 88A of the movable portion 88 is short, and an open state 84Y (see FIG. 12), at which the closed state 84X is cancelled and the distance from the non-movable portion 86 to the distal end portion 88A of the movable portion 88 is longer than when in the closed state 84X. The alternating mechanism 84 is structured so as to switch between the closed state 84X (see FIG. 4) and the open state 84Y (see FIG. 12) each time that the distal end portion 88A is subjected to a predetermined pushing operation. Namely, when the distal end portion 88A is pushed and operated while the alternating mechanism 84 is in the closed state 84X (see FIG. 4), the alternating mechanism 84 is projected-out and held in the open state 84Y (see FIG. 12). Further, when the distal end portion 88A is pushed and operated so as to be pushed-in by a predetermined amount or more while the alternating mechanism 84 is in the open state 84Y (see FIG. 12), the alternating mechanism 84 is held in the closed state 84X (see FIG. 4).

The case 90 is a structure that does not have side walls at the lateral sides of the alternating mechanism 84 that is accommodated therein, and is formed the shape of a flame on the whole, and is disposed with the length direction thereof being the same direction as the alternating mechanism 84. Namely, the case 90 has an upper wall portion 90B and a lower wall portion 90C that extend in the length direction of the case 90, and an outer side vertical wall portion 90A that is disposed at the door handle 40 side (see FIG. 6), and an inner side vertical wall portion 90D that is disposed at the door inner side. The length, in the length direction, of the inner side of the case 90 is set to be sufficiently longer than the length, in the length direction, of the alternating mechanism 84 that is in the open state 84Y (see FIG. 12).

As illustrated in FIG. 5, the distal end portion 88A of the alternating mechanism 84 is thrust against the outer side vertical wall portion 90A of the case 90. A convex portion 90A1, which projects-out toward the door handle 40 side, is formed at the door handle 40 side surface of the outer side vertical wall portion 90A. As illustrated in FIG. 7, at the central portion of the inner side vertical wall portion 90D of the case 90, a through-hole 90H is formed, and a sphere receiving portion 90E, which juts-out from the peripheral portion of the through-hole 90H toward the exterior of the case, is formed.

The base member 92 has a frame-shaped portion 92A that is rectangular and through which the length direction intermediate portion of the case 90 is inserted and withdrawn. The base member 92 has an upper wall portion 92B and a lower wall portion 92C that extends toward the door inner side from the upper and lower portions of the frame-shaped portion 92A, respectively. The respective door inner side end portions of the upper wall portion 92B and the lower wall portion 92C are connected vertically by an inner side structural portion 92D.

Fixing pieces 92E, which project-out toward the door handle 40 side (see FIG. 6 and the like) from the both sides of the vertical direction intermediate portion of the frame-shaped portion 92A, are formed. The convex portions 86T for fixing of the alternating mechanism 84 are fixed to these fixing pieces 92E. Further, as illustrated in FIG. 5, the top surface of the door inner side region of the upper wall portion 90B of the case 90 contacts the bottom surface of the upper wall portion 92B of the base member 92, and the bottom surface of the door inner side region of the lower wall portion 90C of the case 90 contacts the top surface of the lower wall portion 92C of the base member 92. The inner side structural portion 92D has an inner side upper wall portion 92D1 that is formed from the upper wall portion 92B so as to be a step down therefrom, an inner side lower wall portion 92D3 that is formed from the lower wall portion 92C so as to be a step up therefrom, and an inner side vertical wall portion 92D2 that vertically connects the respective door inner side end portions of the inner side upper wall portion 92D1 and the inner side lower wall portion 92D3.

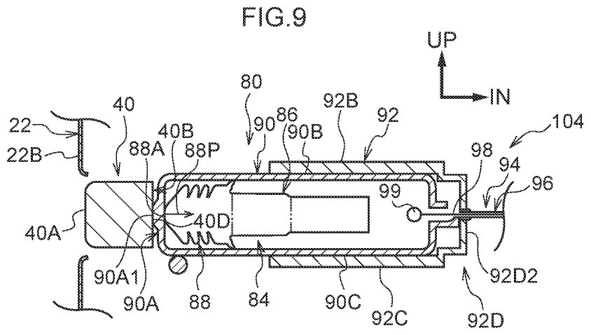

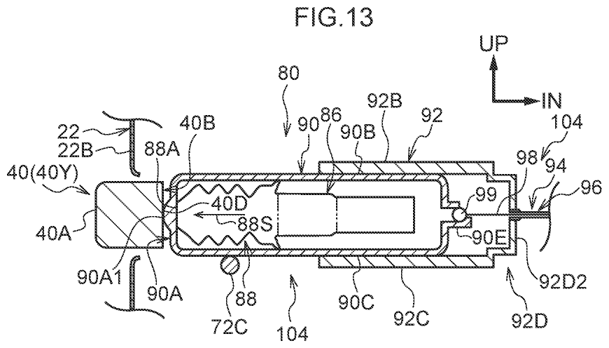

Due to the above, at the alternating mechanism 84, when the outer surface 40A of the door handle 40 that is at the first position 40X is pushed and the door handle 40 moves toward the inner side of the door main body 22 (refer to arrow P in FIG. 8) as illustrated in FIG. 8 and FIG. 9, the movable portion 88 is pushed and operated in the direction toward the vehicle inner side (refer to arrow 88P in FIG. 9) by the flat surface 40D of the convex portion 40C at the inner surface 40B side of the door handle 40, and the movable portion 88 travels a stroke in the direction toward the vehicle outer side (refer to arrow 88S of FIG. 13) as illustrated in FIG. 12 and FIG. 13. Switching operation of the alternating mechanism 84 from the first state to the second state is thereby carried out.

As illustrated in FIG. 7, a through-hole 92H for fixing of an outer casing (also called “outer cable”) 96 is formed in the central portion of the inner side vertical wall portion 92D2. The outer casing 96 structures a portion of a control cable 94. The outer casing 96 has an outer casing main body 96A that is formed in the shape of a tube, and a terminal mounting portion 96B that is tubular and is provided at one end portion of the outer casing main body 96A. The terminal mounting portion 96B is fit into and fixed to the through-hole 92H of the inner side vertical wall portion 92D2 of the base member 92.

Further, in addition to the outer casing 96, the control cable 94 has a wire (also called “inner cable”) 98 that is inserted through the outer casing 96 interior so as to slide freely. One end side of the wire 98 is pulled-out from one end portion of the outer casing 96. A sphere 99 is fixed to the one end portion of the wire 98. The one end side of the wire 98 passes-through the through-hole 92H of the base member 92 and the through-hole 90H of the case 90, and can be disposed at the inner side of the case 90. Further, the sphere 99 can pass-through the through-hole 90H of the case 90. When the wire 98 moves toward the door inner side relative to the case 90, the sphere 99 anchors on the sphere receiving portion 90E.

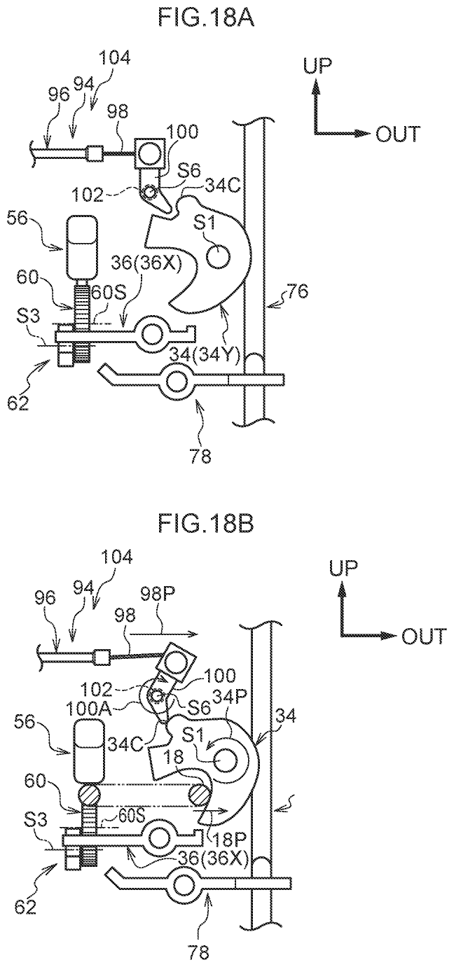

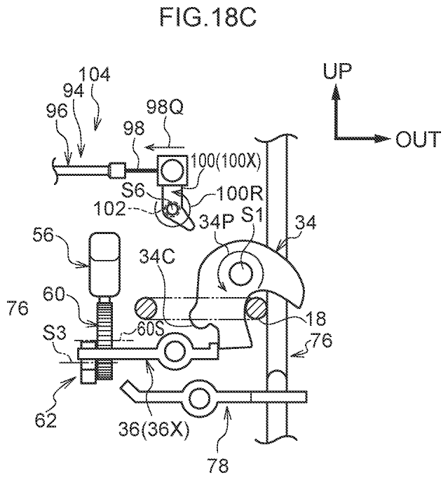

As illustrated in FIG. 2, another end side of the control cable 94 extends to the upper side of the latching mechanism 30. Note that the outer casing 96 is fixed to the door main body 22 via a holding member (not illustrated). As illustrated in FIG. 18A through FIG. 18C, a wire lever 100 is fixed to another end side of the wire 98. The wire lever 100 is supported at the base member 32 (see FIG. 1) via a supporting shaft S6. The supporting shaft S6 is disposed such that the direction that runs along the vehicle longitudinal direction is the axial direction thereof. The wire lever 100 is disposed at a position at which the projecting portion 34C of the latch 34 can abut the wire lever 100 when the latch 34 rotates. When the projecting portion 34C abuts the wire lever 100 at the time when the latch 34 rotates, the wire lever 100 rotates around the supporting shaft S6. Further, in the state in which the wire lever 100 is not abutting the latch 34, the wire lever 100 is urged (refer to arrow 100R) toward reference position 100X illustrated in FIG. 18C by a spring 102 (as an example, a torsion coil spring).

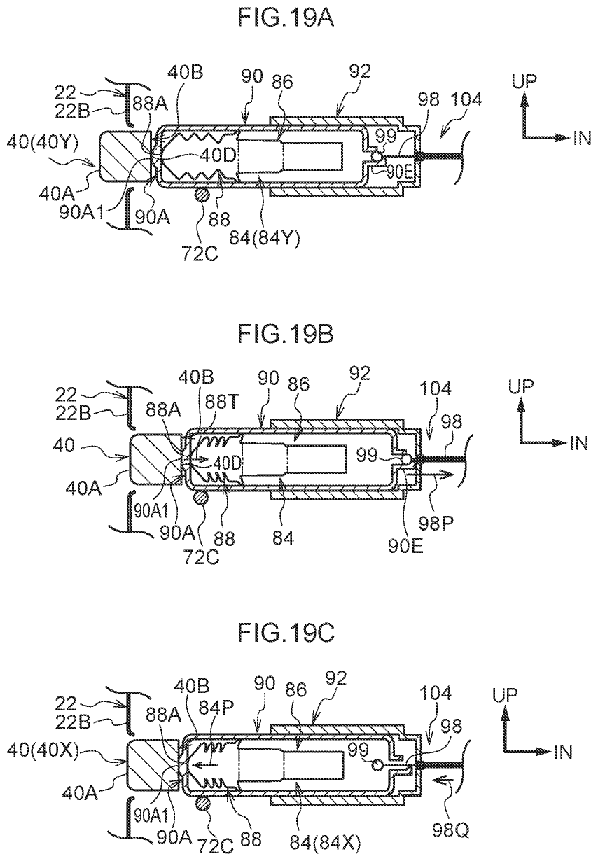

In the present exemplary embodiment, an interlocking mechanism 104 for pushing and operating the alternating mechanism 84 is structured to include the case 90, the base member 92, the control cable 94 and the wire lever 100 that are illustrated in FIG. 2. The interlocking mechanism 104 is structured such that, due to the wire lever 100 rotating (refer to arrow 100A) at the time when the latch 34 illustrated in FIG. 18B rotates, the wire 98 is pulled (refer to arrow 98P), and, due to the case 90 illustrated in FIG. 19B being pulled-in toward the door inner side, the outer side vertical wall portion 90A of the case 90 pushes and operates the movable portion 88. Then, at the time when the latch 34 illustrated in FIG. 18B is pushed (refer to arrow 18P) by the striker 18 and rotates due to the door main body 22 being moved to the closed position, the movable portion 88 that is illustrated in FIG. 1.9B is pushed and operated in the direction toward the vehicle inner side (refer to arrow 88T) by the interlocking mechanism 104 that operates in accordance with the rotation of the latch 34 (refer to arrow 34P), and the movable portion 88 is made to travel a stroke in the direction toward the vehicle inner side. Switching operation from the second state to the first state is thereby carried out at the alternating mechanism 84.

Operation of the present exemplary embodiment is described next.

As illustrated in FIG. 4, the door handle 40 is urged (refer to arrow 82R) by the spring 82 so as to be stored within the door main body 22. In contrast, at the alternating mechanism 84, the distal end portion 88A of the movable portion 88 faces the door handle 40, and alternating operation can be carried out, and the movable portion 88 travels reciprocally along the door thickness direction. Further, the alternating mechanism 84 can, against the urging force of the spring 82, switch between the first state, in which the alternating mechanism 84 maintains the door handle 40 at the first position 40X, and the second state, in which the alternating mechanism 84 maintains the door handle 40 at the second position 40Y (see FIG. 12).

Here, when the outer surface 40A of the door handle 40 that is at the first position 40X is pushed, and the door handle 40 moves toward the door main body 22 inner side as illustrated in FIG. 8, at the alternating mechanism 84, the movable portion 88 is pushed and operated in the direction toward the vehicle inner side by the flat surface 40D of the convex portion 40C at the inner surface 40B side of the door handle 40. Due thereto, as illustrated in FIG. 12, due to the movable portion 88 traveling a stroke in the direction toward the vehicle outer side, the alternating mechanism 84 switchingly operates from the first state (the state illustrated in FIG. 4) to the second state (the state illustrated in FIG. 12). As a result, the door handle 40 is maintained at the second position 40Y by the alternating mechanism 84. Therefore, the operator can easily grasp and pull the door handle 40 that is disposed at the second position 40Y.

Further, in a case in which the door main body 22 is moved in the direction toward the closed position in the order of FIG. 19A, FIG. 19B and FIG. 19C, the alternating mechanism 84 switchingly operates from the second state (the state illustrated in FIG. 12) to the first state (the state illustrated in FIG. 4).

To describe this in detail, first, when the door main body 22 is moved in the direction toward the closed position, the latch 34 which was in the state of FIG. 18A is, as illustrated in FIG. 18B, pushed by the striker 18 (refer to arrow 18P) and rotates (refer to arrow 34P). At this time, the interlocking mechanism 104 operates in accordance with the rotation of the latch 34. Namely, at the interlocking mechanism 104, due to the wire lever 100 rotating in accordance with the rotation of the latch 34, the wire 98 is pulled (refer to arrow 98P). As illustrated in FIG. 19B, when the wire 98 is pulled (refer to arrow 98P), due to the case 90 sliding so as to be pulled-in toward the door inner side interconnectedly with the movement of the sphere 99, the outer side vertical wall portion 90A of the case 90 pushes and operates the movable portion 88 in the direction toward the vehicle inner side. Due thereto, the movable portion 88 is made to travel a stroke over a predetermined amount in the direction toward the vehicle inner side (to the position at which the alternating mechanism 84 is locked). In this state, due to the urging force of the spring 82 (see FIG. 4), the door handle 40 is disposed at a position adjacent to the outer side vertical wall portion 90A of the case 90.

Next, as illustrated in FIG. 18C, when the latch 34 moves to the state of engaging with the striker 18 and the wire lever 100 comes away from the projecting portion 34C of the latch 34, the wire lever 100 returns to the reference position 100X (refer to arrow 100R) due to the spring 102. Due thereto, because the position of the wire 98 also is returned (refer to arrow 98Q), as illustrated in FIG. 19C, the alternating mechanism 84 as well is returned to the position of the closed state 84X (i.e., extends very slightly in the arrow 84P direction).

Due to the above, the alternating mechanism 84 moves from the second state illustrated in FIG. 12 to the first state illustrated in FIG. 4, and the door handle 40 is returned to the first position 40X. Therefore, there is no need to separately carry out an operation for returning the door handle 40.

As described above, in accordance with the vehicle door device 10 of the present exemplary embodiment, the convenience of use is improved due to the projected-out state of the door handle 40 illustrated in FIG. 12 being maintained at the time when the door handle 40 is grasped, and, at the same time, when the door main body 22 is set in the closed state, as illustrated in FIG. 19C, the outer surface 40A of the door handle 40 is returned to the state of being disposed so as to be even with the outer surface 22B of the door main body 22.

Further, in the present exemplary embodiment, when the outer surface 40A of the door handle 40 that is at the first position 40X illustrated in FIG. 4 is pushed, and the door handle 40 moves toward the inner side of the door main body 22 as illustrated in FIG. 8, the switch 52 is operated by the vehicle longitudinal direction rear side end portion 400 that is at the inner surface 40B side of the door handle 40. Then, at the electric unlatching operation mechanism 50 illustrated in FIG. 10, due to the switch 52 being operated, the electric motor 56 operates, and the latching mechanism 30 is moved from the latching state to the unlatching state. In this way, the operator can switch the latching mechanism 30 from the latching state to the unlatching state by the single action of pushing the outer surface 40A of the door handle 40 that is at the first position 40X illustrated in FIG. 4.

To further describe the operation of the electric unlatching operation mechanism 50 that is illustrated in FIG. 10, when the electric motor 56 that is illustrated in FIG. 11A operates, due to the first gear 58 rotating, the second gear 60 rotates (refer to arrow 60R), and the projecting portion 60A that is formed at the second gear 60 pushes the first arm portion 62A of the lever 62 down. Due thereto, the lever 62 rotates (refer to arrow 62R), and the second arm portion 62B of the lever 62 pushes the second arm portion 36B of the pole 36 up. As illustrated in FIG. 11B, when the second arm portion 36B of the pole 36 is pushed-up, the pole 36 rotates (refer to arrow 36R), and therefore, the first arm portion 36A of the pole 36 falls, and the distal end anchor portion 36A1 of the first arm portion 36A of the pole 36 comes away from the anchor portion 34B of the latch 34. At this time, the latch 34 rotates toward the unlatching position 34Y (refer to arrow D) due to the urging force of the unillustrated spring, and the latch 34 comes away from the striker 18.

Note that, after the operator cancels the restricting of opening the door main body 22 illustrated in FIG. 12, the operator may grasp the door handle 40 and open the door main body 22, or the operator may grasp an end edge portion 22Z of the opening portion where the door handle 40 is provided at the door main body 22 and open the door main body 22. In this way, in the present exemplary embodiment, degrees of freedom can be provided to the operation of the operator.

Further, in the present exemplary embodiment, when the door handle 40 that is illustrated in FIG. 12 and the like is operated from the second position 40Y in the direction of opening the door main body 22, as illustrated in FIG. 14, the door handle 40 moves to the third position 40Z at which the door handle 40 projects-out further toward the vehicle outer side than at the second position 40Y (see FIG. 12) in a state in which the door handle 40 is not supported by the alternating mechanism 84. In a case in which the latching mechanism 30 illustrated in FIG. 2 is in the latching state, when the door handle 40 moves from the second position 40Y (see FIG. 12) to the third position 40Z (see FIG. 14), interconnectedly with the movement of the door handle 40, the mechanical unlatching operation mechanism 70 illustrated in FIG. 16 moves the latching mechanism 30 from the latching state to the unlatching state. Therefore, even if a power failure occurs, the operator can move the latching mechanism 30 from the latching state to the unlatching state.

To further describe the operation of the mechanical unlatching operation mechanism 70, when the door handle 40 rotates from the second position 40Y illustrated in FIG. 12 to the third position 40Z illustrated in FIG. 14, the crank mechanism 72, which is pushed by the inclined surface 401 at the inner surface 40B side of the door handle 40, rotates as illustrated in FIG. 14. Due thereto, the rod 76 that is illustrated in FIG. 16 falls. When the rod 76 falls, as illustrated in FIG. 17A and FIG. 17B, the ring portion 78R of the lever 78 with a ring is pushed-down by the lower portion 76C of the rod 76, and the lever 78 with a ring rotates (refer to arrow B in FIG. 171). Due thereto, the curved portion 78C of the lever 78 with a ring pushes the second arm portion 36B of the pole 36 upward, and the pole 36 thereby rotates (refer to arrow C). At this time, because the first arm portion 36A of the pole 36 falls, the distal end anchor portion 36A1 of the first arm portion 36A of the pole 36 comes away from the anchor portion 34B of the latch 34. When the distal end anchor portion 36A 1 of the first arm portion 36A of the pole 36 comes away from the anchor portion 34B of the latch 34, due to the urging force of the unillustrated spring, the latch 34 rotates toward the unlatching position 34Y (refer to arrow D), and the latch 34 comes away from the striker 18.

Note that, in the above-described exemplary embodiment, the door handle 40 that is illustrated in FIG. 2 and the like is provided at the door main body 22 so as to be rotatable. However, as a modified example of the above-described exemplary embodiment, the door handle may be provided so as to, for example, be able to project-out from and sink-into the door main body by moving parallel to the door thickness direction.

Further, a structure may be employed in which the electric unlatching operation mechanism 50 of the above-described exemplary embodiment is not provided and another unlatching operation mechanism is provided. Further, a structure may be employed in which the mechanical unlatching operation mechanism 70 of the above-described exemplary embodiment is not provided and another unlatching operation mechanism is provided.

Note that the above-described exemplary embodiment and above-described modified examples may be implemented by being combined together appropriately.

Although examples of the present disclosure have been described above, the present disclosure is not limited to the above, and may of course be implemented by being modified in various ways other than the above within a scope that does not depart from the gist thereof.

What is claimed is:

1. A vehicle door device comprising:
a latching mechanism provided at a door main body of a vehicle, wherein, when the door main body is in a closed state, the latching mechanism being configured to switch between a latching state, in which a latch engages with a striker that is at a vehicle body side and opening of the door main body is restricted, and an unlatching state, in which the latch is not engaged with the striker and opening of the door main body is not restricted;
a door handle provided at the door main body, the door handle being configured to move between a first position in which the door handle is disposed to be even with an outer surface of the door main body, and a second position in which at least a portion of the door handle projects-out toward a vehicle outer side with respect to the first position and in which an operator can grasp the door handle, the door handle being permitted to move from the first position toward an inner side of the door main body; and
a door handle projecting/pulling-in mechanism being configured to carry out a door handle projecting operation, in which the door handle projecting/pulling-in mechanism moves the door handle from the first position to the second position and maintains a state in which the door handle is at the second position, and a door handle pulling-in operation, in which the door handle projecting/pulling-in mechanism moves the door handle from the second position to the first position and maintains a state in which the door handle is at the first position, the door handle projecting/pulling-in mechanism including:
an urging member being configured to urge the door handle to be stored within the door main body, and
an alternating mechanism that carries out an alternating operation, the alternating mechanism being configured such that a distal end portion of a movable portion faces the door handle and the movable portion travels along a door thickness direction, and the alternating mechanism being able to, against urging force of the urging member, switch between a first state in which the door handle is maintained at the first position and a second state in which the door handle is maintained at the second position,
wherein, when an outer surface of the door handle in the first position is pushed and the door handle moves toward the inner side of the door main body, the alternating mechanism carries out a switching operation from the first state to the second state, by the movable portion being pushed in a direction toward a vehicle inner side by a portion of an inner surface side of the door handle and the movable portion being made to travel a stroke in a direction toward a vehicle outer side, and
wherein, when the latch is pushed by the striker and rotates due to the door main body being moved in a direction of a closed position, the alternating mechanism carries out a switching operation from the second state to the first state, by the movable portion being pushed in the direction toward the vehicle inner side by an interlocking mechanism that operates in accordance with rotation of the latch and the movable portion being made to travel a stroke in the direction toward the vehicle inner side.

2. The vehicle door device of claim 1, further comprising an electric unlatching operation mechanism being configured to move the latching mechanism from the latching state to the unlatching state due to an electric actuator operating by operation of a switch,
wherein the electric unlatching operation mechanism is structured such that, when the outer surface of the door handle in the first position is pushed and the door handle moves toward the inner side of the door main body, the switch is operated by another portion of the inner surface side of the door handle.

3. The vehicle door device of claim 1, wherein:
when the door main body is operated in an opening direction from the second position, the door handle moves to a third position at which the door handle projects-out further toward the vehicle outer side than at the second position, in a state in which the door handle is not supported by the alternating mechanism, and
the vehicle door device includes a mechanical unlatching operation mechanism that, in a case in which the latching mechanism is in the latching state, when the door handle moves from the second position to the third position, moves the latching mechanism from the latching state to the unlatching state interconnectedly with movement of the door handle.
